(19) United States
(12) Patent Application Publication
(10) Pub. No.: US 2026/0348460 A1
(43) Pub. Date: Nov. 5, 2026

(54) CONTINUOUSLY VARIABLE TRANSMISSION

(71) Applicant: Igor Aleksandrovich DOLMATOV, Bratsk (RU)

(72) Inventor: Igor Aleksandrovich DOLMATOV, Bratsk (RU)

(21) Appl. No.: 19/487,070

(22) PCT Filed: Jun. 11, 2024
(86) PCT No.: PCT/RU2024/000185

§ 371 Date: Nov. 24, 2025

(30) Foreign Application Priority Data
Jun. 15, 2023 (RU) 2023115678

(51) Int. Cl. F16H 37/02; F16H 9/26

(52) U.S. Cl. CPC F16H 37/022; F16H 9/26

(57) ABSTRACT

The invention relates to drive devices in which the speed and direction of rotation of an output shaft can be continuously varied. A continuously variable transmission comprises a primary shaft, a variator, a three-link planetary gear, and an output shaft. The variator consists of a drive pulley and a driven pulley which are coupled by a belt. The continuously variable transmission further comprises a frictional toothed clutch configured to be capable of coupling and uncoupling the primary shaft and a first pinion that is coupled to a first and a second gear. The continuously variable transmission still further comprises a toothed clutch configured to be capable of coupling and uncoupling the drive pulley of the variator and the second gear. The first gear is coupled to the carrier of the planetary gear. The annulus of the planetary gear is coupled to the driven pulley of the variator, and the planet gears of the planetary gear are coupled to the sun gear, which is coupled to the following serially coupled elements: the output shaft, a second pinion, and a third gear. The result is that of simplifying the structure of the continuously variable transmission and increasing the reliability thereof.

### TECHNICAL FIELD

The invention relates to mechanical engineering, namely to drive devices with a continuously variable speed and direction of rotation of an output shaft, and can be used in land transport equipment.

### BACKGROUND OF THE INVENTION

RU 2656941 (published on 7 Jun. 2018, IPC F16H 15/50) discloses a continuously variable transmission. The continuously variable transmission comprises a friction variator and a simple three-link planetary gear consisting of a sun gear, an annulus and a carrier with planet gears. Input and output shafts are mounted in parallel, a ring gear is fixed on the input shaft with a clutch for activating a leading cylindrical pinion, which is freely mounted on the input shaft and engaged with a driven cylindrical gear mounted on the annulus housing. A clutch for locking the planetary gear or stopping the annulus is installed on the ring gear of the tubular shaft of the housing. A small friction wheel is mounted on a key of the input shaft, pressed against a large friction wheel of the driven shaft, which is connected to the sun gear by a bevel gear and shaft. The carrier is mounted on the output shaft. The ring gear of this shaft is located next to the ring gears of the tubular shaft of the annulus housing and the continuously variable transmission housing.

RU 2748081 (published on 19 May 2021, IPC F16H 37/08) discloses a drive device comprising a differential at the input, a planetary train at the output, the carrier of which is made together with an output shaft of the device, and a V-belt variator connected to the differential and the planetary train through gears. The revolutions of the semi-axes of the differential are changed by changing the gear ratio of the variator and are separately fed to the sun and crown gears of the planetary train. One of the flows is fed in the opposite direction of rotation. The revolutions of the sun and crown gears are differentially dependent. The axes of the planet gears are carried away by the total rotation speed of the sun and crown gears in the direction of rotation of the input shaft or in the opposite direction with zero crossing.

The Jatco JF015E continuously variable transmission (hereinafter-prototype) is well-known, which is characterized by a sequential arrangement of a torque converter, a front and rear gear package (compound gear), a variator and a two-stage gearbox with an integrated inter-wheel differential. The disadvantage of this continuously variable transmission is the presence of the torque converter and the front and rear gear package (compound gear) in its design, as well as a limited operating life of 200,000-220,000 kilometers. This is due to belt stretching, wear of the belt and working surfaces of the variator pulleys. The Jatco JF015E continuously variable transmission is installed on passenger cars manufactured by Nissan, Mitsubishi, Chevrolet, Daewoo, etc.

### SUMMARY OF THE INVENTION

The technical problem underlying the present invention is to expand the range of V-belt continuously variable transmissions.

The technical result achieved by the present invention is an increase in the operating life of a V-belt continuously variable transmission.

Additional technical results include a simplification of the structure of the continuously variable transmission and an increase in its reliability.

The technical result is achieved by the present invention, which offers a continuously variable transmission. The proposed continuously variable transmission comprises: a primary shaft; a variator comprising a drive pulley and a driven pulley that are connected by a belt; a three-link planetary gear comprising a carrier with planet gears, an annulus and a sun gear; and an output shaft. Unlike the prototype, the proposed continuously variable transmission further comprises a frictional toothed clutch configured to connect and disconnect the primary shaft and a first pinion connected to first and second gears, and a toothed clutch configured to connect and disconnect the drive pulley of the variator and the second gear. The first gear is connected to the carrier of the planetary gear, and the annulus of the planetary gear is connected to the driven pulley of the variator. The planet gears of the planetary gear are connected to the sun gear which is serially connected to the output shaft, a second pinion and a third gear.

### BRIEF DESCRIPTION OF THE DRAWINGS

The present invention is illustrated by the following drawings:

FIG. 1 shows a kinematic diagram of a continuously variable transmission;

FIG. 2 shows a first variator diagram;

FIG. 3 shows a second variator diagram;

FIG. 4 shows a third variator diagram.

The following designations are used in the drawings:
1—primary shaft;
2—frictional toothed clutch;
3—first pinion;
4—first gear;
5—second gear;
6—drive pulley;
7—driven pulley;
8—belt;
9—carrier;
10—axes;
11—planet gears;
12—sun gear;
13—shaft;
14—second pinion;
15—third gear;
16—clutch;
17—annulus;
18—crankshaft;
19—internal combustion engine;
20—drive wheels;
21—housing
22—inter-wheel differential.

### DETAILED DESCRIPTION OF THE INVENTION

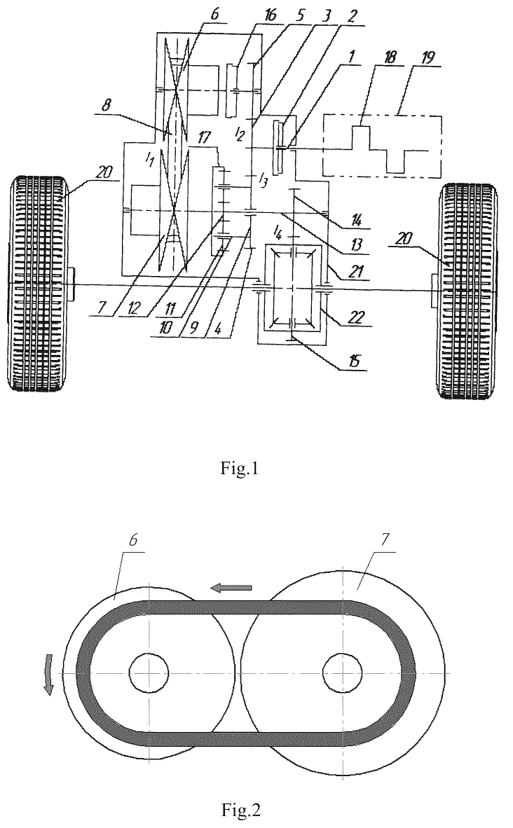

FIG. 1 shows a kinematic diagram of a continuously variable transmission. In accordance with the shown kinematic diagram, a primary shaft 1 of the continuously variable transmission is connected to a frictional toothed clutch 2 and a first pinion 3 that are located on the same axis. The frictional toothed clutch is configured to connect and disconnect the primary shaft 1 and the first pinion 3. The first pinion 3 engages with a first gear 4 and a second gear 5.

The variator comprises a drive pulley 6 and a driven pulley 7 which are interconnected by a belt 8.

The first gear 4 is connected to a carrier 9 of a three-link planetary gear that is located on the same axis. Planet gears 11 are installed on axes 10 of the carrier 9. The planet gears 11 engage with a sun gear 12 connected to serially connected output shaft 13, second pinion 14 and third gear 15.

The second gear 5 is connected to a clutch 16 configured to connect and disconnect the second gear 5 and the drive pulley 6 of the variator. The driven pulley 7 of the variator is connected to an annulus 17. The annulus 17 engages with the planet gears 11.

The primary shaft 1 is connected to a crankshaft 18 of an internal combustion engine 19. The third gear 15 is connected to drive wheels 20 via an inter-wheel differential 22.

The continuously variable transmission is assembled in a housing 21.

The rotation speed of the gear 15, equal to the rotation speed of the drive wheels 20, is defined by the formula:

$${n}_{15} = {n}_{1} \frac{\frac{{U}_{17 \; 9}^{12}}{{i}_{3}} - \frac{1}{{i}_{1} {i}_{2}}}{{i}_{4} {U}_{12 \; 17}^{9}} ;$$

where n₁ is the rotation speed of the primary shaft 1, equal to the rotation speed of the crankshaft 18, rpm;

$${U}_{179}^{12}$$

is the gear ratio of the planetary stage with the stopped sun gear 12.

The gear ratio of the planetary gear is determined by the following formula:

$${U}_{17 \; 9}^{12} = 1 + \frac{{z}_{12}}{{z}_{17}} ;$$

where z₁₂ is the number of teeth of the sun gear 12;
z₁₇ is the number of teeth of the annulus 17;
i₃ is the gear ratio of the gear pair of the first pinion 3 and the first gear 4.

The gear ratio of the gear pair 3 and 4 is determined by the following formula:

$${i}_{3} = \frac{{z}_{4}}{{z}_{3}} ;$$

where z₃ is the number of teeth of the pinion 3;
z₄ is the number of teeth of the first gear 4;
i₁ is the variable gear ratio of the variator.

The variable gear ratio of the variator is determined by the following formula:

$${i}_{1} = \frac{{n}_{7}}{{n}_{6}} ;$$

where n₆ is the rotation speed of the drive pulley of the variator 6, rpm;
n₇ is the rotation speed of the driven pulley of the variator 7, rpm;
i₂ is the gear ratio of the gear pair 3 and 5. It is determined by the following formula:

$${i}_{2} = \frac{{z}_{5}}{{z}_{3}} ;$$

z₅ is the number of teeth of the gear 5.
i₄ is the gear ratio of a single-stage gearbox. It is determined by the formula:

$${i}_{4} = \frac{{z}_{15}}{{z}_{14}} ;$$

z₁₄ is the number of teeth of the pinion 14;
z₁₅ is the number of teeth of the gear 15;

$${U}_{1217}^{9}$$

is the gear ratio of the planetary gear with the stopped carrier 9.

The transmission has the following operating modes: “Parking”, “Dynamic parking”, “Reversing”, “Neutral position”, “Forward movement”.

In the “Parking” mode, the primary shaft 1 is disconnected from the first pinion 3 by means of the frictional toothed clutch 2.

In the “Neutral position” mode, the drive pulley 6 of the variator is disconnected from the second gear 5 by means of the clutch 16.

In the “Dynamic Parking”, “Reverse movement”, and “Forward movement” modes, the transmission operates as follows. The rotation of the primary shaft 1 through the engaged frictional toothed clutch 2 and pinion 3 simultaneously causes an oppositely directed rotation of the gears 5 and 4. The rotation of the second gear 5 is transmitted to the engaged clutch 16 and the drive pulley 6 of the variator which transmits rotation through the belt 8 to the driven pulley of the variator 7. The driven pulley 7 transmits rotation to the annulus 17. The rotation of the first gear 4 is transmitted to the carrier 9 which transmits the diametrical rotation to the axes 10 of the planet gears and to the planet gears 12.

In the “Dynamic Parking” mode, the rotating planet gears 11 that simultaneously engage with the annulus 17 and the sun gear 12 do not cause rotation of the sun gear 12, i.e. the rotation speed of the third gear 15 is zero, n₁₅=0. This is because the ratio of the rotation speeds of the annulus 17 and the carrier 9 is maintained, which respects the following equality of operation of the variator:

$${i}_{1} = \frac{{i}_{3}}{{i}_{2} {U}_{17 \; 9}^{12}}$$

In this case, the variator belt (FIG. 2) is in a certain median position of its control range, which is calculated based on the chain of gear ratios of the entire transmission. Thus, in the “Dynamic parking” mode, the rotation speed of the output link of the gear 15 has a zero value, which means that a torque converter is not required in this transmission design.

In the “Reversing” mode, the rotating planet gears 11 that simultaneously engage with the annulus 17 and the sun gear 12 cause an oppositely directed rotation of the sun gear 12, the shaft 13 and the pinion 14. The pinion 14 causes the gear 15 to rotate in the opposite direction, which does not coincide with the direction of rotation of the primary shaft 1. This is because the ratio of the rotation speeds of the annulus 17 and the carrier 9 is maintained, which respects the following operation condition of the variator:

$${i}_{1} \leq \frac{{i}_{3}}{{i}_{2} {U}_{17 \; 9}^{12}}$$

The equal sign means that the “Reversing” mode has a range of rotation speeds of the gear 15, which includes a zero value, n₁₅=0.

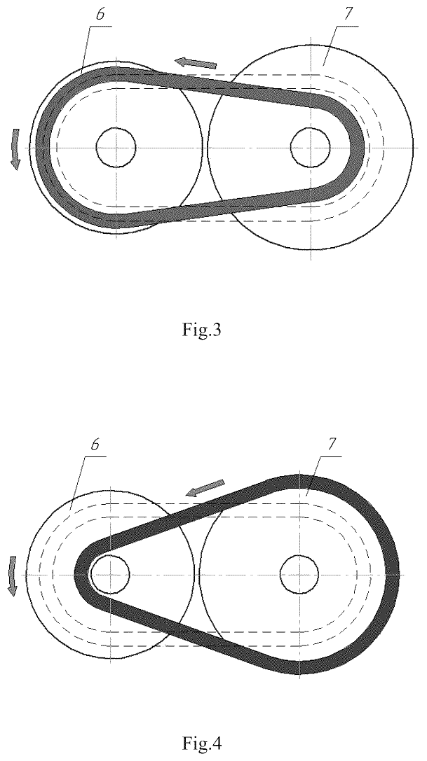

In the “Reversing” mode, the variator accelerates (FIG. 3)—the higher the rotation speed of the driven pulley 7, the greater the negative rotation speed of the output link of the gear 15 relative to the primary shaft 1. Thus, for the transmission to operate in the “Reversing” mode, a front and rear gear package (compound gear) is not required.

In the “Forward movement” mode, the rotating planet gears 11 that simultaneously engage with the annulus 17 and the sun gear 12 cause the coincident rotation of the sun gear 12, the shaft 13 and the pinion 14. The pinion 14 causes the gear 15 to rotate in the opposite direction, which coincides with the direction of rotation of the primary shaft 1. This is because the ratio of the rotation speeds of the annulus 17 and the carrier 9 is maintained, which respects the following operation condition of the variator:

$${i}_{1} \geq \frac{{i}_{3}}{{i}_{2} {U}_{17 \; 9}^{12}}$$

The equal sign means that the “Forward movement” mode has a range of rotation speeds of the gear 15, which includes a zero value, n₁₅=0.

In the “Forward movement” mode, the variator slows down (FIG. 4)—the lower the rotation speed of the driven pulley 7, the higher the rotation speed of the output link of the gear 15 relative to the primary shaft 1. Thus, for the transmission to operate in the “Forward movement” mode, a front and rear gear package (compound gear) is not required.

The frictional toothed clutch 2 is configured to disconnect the rotating primary shaft 1 from the pinion 3 when the transmission operates in the “Parking” mode and smoothly connect the rotating primary shaft 1 with the pinion 3 when the transmission operates in the “Dynamic parking” mode. The clutch 16 is designed to protect the variator from overload when the transmission operates in the “Dynamic parking” mode in the case when the following condition is not met:

$${i}_{1} = \frac{{i}_{3}}{{i}_{2} {U}_{17 \; 9}^{12}}$$

Given below is an example of calculating the rotation speed of the gear 15 when the transmission operates in the “Dynamic parking”, “Reversing”, and “Forward movement” modes.

The following values are used to calculate the rotation speed of the gear n₁₅:
i₂=1.1
i₃=1.3
i₄=4.5

$${U}_{179}^{12} = 1.3$$

$${u}_{1217}^{9} = 0.3 ,$$

the control range of the variator is D=2.81.

When the transmission operates in the “Dynamic parking” mode, the rotation speed of the primary shaft 1 is assumed to be n₁=700-3500 rpm or more.

By meeting the condition:

$${i}_{1} = \frac{{i}_{3}}{{i}_{2} {U}_{17 \; 9}^{12}}$$

one can obtain iᵢ=0.9091, n₁₅=0 rpm.

When the transmission operates in the “Reversing” mode, the rotation speed of the primary shaft 1 is assumed to be n₁=700-1500 rpm.

By meeting the condition:

$${i}_{1} \leq \frac{{i}_{3}}{{i}_{2} {U}_{17 \; 9}^{12}}$$

and limiting the control range of the variator, one can obtain i₁=0.9091-0.7, n₁₁=0 to −476 rpm.

When the transmission operates in the “Forward movement” mode, the rotation speed of the primary shaft 1 is assumed to be n₁=700-3500 rpm.

By meeting the condition:

$${i}_{1} \geq \frac{{i}_{3}}{{i}_{2} {U}_{17 \; 9}^{1}}$$

and limiting the control range of the variator, one can obtain i₁=0.9091-2.77, n₁₅=0-1656.6 rpm.

When determining the speed of a vehicle using the formula V=0.19Dn₁₅ (km/h), where the wheel diameter is D=0.7 m (225/55R18 tire), one can obtain the following values:

| | | Crankshaft | Wheel | |
|---|---|---|---|---|
| Operating | Gear ratio | rotation | rotation | Vehicle |
| modes of the | of the | speed | speed | speed V, |
| transmission | variator, i₁ | n₁, rpm | n₁₅, rpm | km/h |
| Dynamic | 0.9091 | 700 and more | 0 | 0 |
| parking | | | | |
| Forward | 0.9091-2.77 | 700-3500 | 0-1656 | 0-220 |
| movement | | | | |
| Reversing | 0.9091 . . . 0.7 | 700-1500 | −476-0 | 0-63 |

The torque M₁₅ at the output link of the gear 15 in the “Reversing” and “Forward movement” modes is determined by the formula:

M₁₅=M₁Uₖ
where: M₁ is the torque on the primary shaft 1, equal to the torque of the internal combustion engine; Uₖ is the gear ratio of the transmission.

$${U}_{k} = \frac{{i}_{4} {U}_{12 \; 17}^{9}}{\frac{{U}_{17 \; 9}^{12}}{{i}_{3}} - \frac{1}{{i}_{1} {i}_{2}}}$$

A 50% increase in operating life is achieved by the fact that the torque received by the primary shaft 1 from the internal combustion engine (ICE) using the pinion 3 and the gears 4 and 5 is divided into two equal parallel flows, one of which rotates the carrier 9, and the second one rotates the annulus 17 through the variator. As a result, the variator perceives 50% of the torque of the internal combustion engine. Given the gear ratio i₂, the variator torque My when the transmission operates in the “Reversing” and “Forward movement” modes is determined by the formula:

M_{V}=0.5M₁i₂

Thus, it is concluded that the belt tension, the wear of the belt and working surfaces of the variator pulleys are halved over a period of operation equal to the period of operation of the prototype, and the transmission with the built-in variator designed for maximum torque, as in the prototype, has an operational life increased by 50% to 300,000-320,000 km when using materials with the same wear-resistant and strength characteristics of the transmission.

1. A continuously variable transmission comprising:
a primary shaft;
a variator comprising a drive pulley and a driven pulley that are connected by a belt;
a three-link planetary gear comprising a carrier with planet gears, an annulus and a sun gear; and
an output shaft;
wherein the continuously variable transmission further comprises:
a frictional toothed clutch configured to connect and disconnect the primary shaft and a first pinion connected to a first gear and a second gear;
a toothed clutch configured to connect and disconnect the drive pulley of the variator and the second gear;
wherein the first gear is connected to the carrier of the planetary gear;
wherein the annulus of the planetary gear is connected to the driven pulley of the variator; and
wherein the planet gears of the planetary gear are connected to the sun gear, the sun gear being connected to the output shaft, a second pinion and a third gear which are serially connected elements.
